(19) United States
(12) Patent Application Publication
(10) Pub. No.: US 2008/0287284 A1
(43) Pub. Date: Nov. 20, 2008

(54) Fluid Catalytic Cracking Additive

(76) Inventors: Julie Ann Francis, Houston, TX (US); Lin Luo, Lake Jackson, TX (US); Darrell Ray Rainer, Houston, TX (US)

Correspondence Address: Albemarle Netherlands B.V.;Patent and Trademark Department, 451 Florida Street, Baton Rouge, LA, 70801, US

(21) Appl. No.: 11/908,084

(22) PCT Filed: Mar. 8, 2006
(86) PCT No.: PCT/EP2006/060573

§ 371 Date: May 12, 2008

Related U.S. Application Data
(60) Provisional application No. 60/659,416, filed on Mar. 9, 2005.

(51) Int. Cl. B01J 21/04; B01D 53/56; B01D 53/62; B01J 23/50; B01J 23/72; B01J 23/44; B01J 21/16

(52) U.S. Cl. 502/63; 423/239.1; 423/247; 502/74

(57) ABSTRACT

The present invention relates to a catalyst composition comprising rhodium supported on an anionic clay. This catalyst composition is suitable as CO combustion additive in fluid catalytic cracking units. Compared to prior art CO combustion additives, the formation of NOₓ is minimized.

The present invention relates to a catalyst additive comprising rhodium supported on an anionic clay support, its production, and its use in a fluid catalytic cracking process.

Fluid catalytic cracking (FCC) catalysts cycle between a reactor (generally a riser reactor) and a regenerator. In the regenerator, the coke that has deposited on the FCC catalyst during the cracking reaction is burned off. This regeneration not only results in the formation of CO and CO₂, but, due to the presence of nitrogen and sulfur-containing species in the coke, also in the formation of NO, (mainly NO) and SOₓ. These gases are emitted from the FCC unit.

In order to reduce the CO emissions, CO combustion promoters (generally Pt-containing compounds) can be added to the FCC unit to accelerate the oxidation of CO. Unfortunately, however, CO combustion promoters generally promote the formation of NO.

It would therefore be desirable to provide a CO combustion additive which does not promote NO formation, or only does so to a minimized extent.

U.S. Pat. No. 4,290,878 discloses a CO combustion additive comprising Pt and Ir.

Iliopoulou et al., Appl. Catal. B, 47 (2004)165-175, studied CO oxidation and NO reduction over Rh-containing compositions. The Rh in these compositions was supported on either MgO.Al₂O₃ spinel or alumina. Alumina supports resulted in better CO combustion than spinel supports.

The search for further and improved catalyst additive compositions is still going on. The present invention provides such a further, improved composition.

The catalyst composition according to the invention comprises rhodium supported on an anionic clay support. As will be shown in the examples below, the use of anionic clay support compared to the use of alumina supports results in reduction of the NOₓ emissions, while the CO combustion is at least similar.

In the catalyst composition according to the invention, Rh is supported on the anionic clay. A suitable method to prepare this catalyst composition is impregnation of an existing anionic clay with a solution containing a rhodium salt. This solution is preferably aqueous, but may also be organic in nature.

Suitable rhodium salts are rhodium chloride, rhodium nitrate, and other Rh complexes which are soluble in the liquid used for making the impregnation solution.

Any conventional technique can be used for impregnation. Examples are wet impregnation or incipient wetness impregnation.

It is emphasized that anionic clay with Rh supported on it (as in the present invention) differs from anionic clay that is doped with Rh.

Rh-doped anionic clay refers to anionic clay prepared in the presence of a Rh compound. Several preparation methods may result in Rh-doped anionic clay, for instance: (i) co-precipitation of a divalent metal salt, a trivalent metal salt, and a rhodium salt, followed by aging of the precipitate, (ii) calcination of an existing anionic clay, followed by rehydration of the calcined anionic clay in an aqueous Rh-containing solution, or (iii) aging of a slurry comprising a divalent metal compound, a trivalent metal compound, and a rhodium compound. Using these methods, Rh will be distributed throughout the entire anionic clay structure.

The Rh-containing anionic clay according to the present invention, however, is prepared by impregnation of an already existing anionic clay with Rh. This results in Rh particles on the surface of the anionic clay support. It is evident that the Rh in such impregnated clays is generally better accessible for reactants than the Rh in Rh-doped anionic clays.

Rh is present on the anionic clay in a preferred amount of about 0.001 to about 2.0 wt %, more preferably about 0.01 to about 2.0, even more preferably about 0.01 to about 1.0 wt %, and most preferably about 0.01 to about 0.15 wt %, measured as Rh metal and based on the weight of the anionic clay.

Additional metals can be present in the catalyst composition, such as Ag, Pd, and/or Cu. These metals are preferably present on the anionic clay in an amount of about 0.001 to about 2.0 wt %, more preferably about 0.01 to about 2.0, even more preferably about 0.01 to about 1.0 wt %, and most preferably about 0.01 to about 0.30 wt %.

The additional metal(s) and Rh can be co-impregnated on the anionic clay. Alternatively, Rh and the additional metal(s) can be impregnated sequentially.

Anionic clays are layered structures corresponding to the general formula:

[Mₘ²⁺Mₙ³⁺(OH)₂ₘ₊₂ₙ.](X_{n/z}^{z}^{^{−}}).bH₂O

wherein M²⁺ is a divalent metal, M³⁺ is a trivalent metal, m and n have a value such that m/n=about 1 to about 10, preferably about 1 to about 6, and b has a value in the range of from about 0 to about 10, generally a value of about 2 to about 6, and often a value of about 4. X is an anion with valance z, such as CO₃²⁻, OH⁻, or any other anion normally present in the interlayers of anionic clays. It is more preferred that m/n should have a value of about 2 to about 4, more particularly a value close to about 3.

In the prior art, anionic clays are also referred to as layered double hydroxides and hydrotalcite-like materials.

Anionic clays have a crystal structure consisting of positively charged layers built up of specific combinations of metal hydroxides between which there are anions and water molecules. Hydrotalcite is an example of a naturally occurring anionic clay in which Al is the trivalent metal, Mg is the divalent metal, and carbonate is the predominant anion present. Meixnerite is an anionic clay in which Al is the trivalent metal, Mg is the divalent metal, and hydroxyl is the predominant anion present.

In hydrotalcite-like anionic clays the brucite-like main layers are built up of octahedra alternating with interlayers in which water molecules and anions, more particularly carbonate ions, are distributed. The interlayers may contain anions such as NO₃⁻, OH, Cl⁻, Br⁻, I⁻, SO₄²⁻, SiO₃²⁻, CrO₄²⁻, BO₃²⁻, MnO₄⁻, HGaO₃²⁻, HVO₄²⁻, CIO₄⁻, BO₃²⁻, pillaring anions such as V₁₀O₂₈⁶^{^{−}} and MO₇O₂₄⁶^{^{−}}, monocarboxylates such as acetate, dicarboxylates such as oxalate, alkyl sulfonates such as lauryl sulfonate.

For the purpose of the present invention various types of anionic clays are suitable. Examples of suitable trivalent metals (M³⁺) present in the (thermally treated) anionic clay include Al³⁺, Ga³⁺, In³⁺, Bi³⁺, Fe³⁺, Cr³⁺, Co³⁺, Sc³⁺, La³⁺, Ce³⁺, and combinations thereof. Suitable divalent metals (M²⁺) include Mg²⁺, Ca²⁺, Ba²⁺, Zn²⁺ Mn²⁺, Co²⁺, Mo²⁺, Ni²⁺, Fe²⁺, Sr²⁺, Cu²⁺, and combinations thereof. Especially preferred anionic clays are Mg—Al and Zn—Al anionic clays.

Suitable anionic clays can be prepared by any known process. Examples are co-precipitation of soluble divalent and trivalent metal salts and slurry reactions between water-soluble divalent and trivalent metal compounds, e.g. oxides, hydroxides, carbonates, and hydroxycarbonates. The latter method provides a cheap route to anionic clays.

The catalyst composition according to the present invention may additionally comprise conventional catalyst components such as silica, alumina, aluminosilicates, zirconia, titania, boria, kaolin, acid leached kaolin, dealuminated kaolin, bentonite, (modified or doped) aluminium phosphates, zeolites (e.g. zeolite X, Y, REY, USY, RE-USY, or ZSM-5, zeolite beta, silicalites), phosphates (e.g. meta or pyro phosphates), sorbents, fillers, and combinations thereof.

A preferred catalyst component present in the composition according to the present invention is alumina.

The catalyst composition preferably comprises about 1.0 to about 100 wt %, more preferably about 1.0 to about 40 wt %, even more preferably about 3.0 to about 25 wt %, and most preferably about 3.0 to about 15 wt % of Rh-containing anionic clay.

The catalyst composition according to the invention preferably has a particle size of about 20 to about 2000 microns, preferably about 20 to about 600 microns, more preferably about 20 to about 200 microns, and most preferably about 30 to about 100 microns.

The catalyst composition according to the invention is very suitable for the reduction of NOₓ and CO emissions from the FCC regenerator. Therefore, the invention also relates to the use of this catalyst composition in a FCC process. The catalyst composition according to the invention is preferably used as an additive, in combination with a conventional FCC catalyst. The catalyst composition according to the invention and the FCC catalyst can be collectively incorporated into a matrix, thereby creating one type of catalyst particle. On the other hand, a physical mixture of two types of particles can be used: particles comprising the catalyst composition according to the invention (additive particles) and FCC catalyst particles. The latter has the advantage that the amount of the catalyst composition according to the invention to be added to the FCC unit can be easily adapted to the specific conditions in the unit and the hydrocarbon feed to be processed.

### EXAMPLES

### Example 1

Two anionic clay-supported rhodium compositions were prepared:

Rh(500)/HTC, containing 500 ppm (0.050 wt %) Rh on hydrotalcite, and

Rh(150)/HTC, containing 150 ppm (0.015 wt %) Rh on hydrotalcite.

These compositions were prepared by incipient wetness impregnation of hydrotalcite with aqueous solutions of Rh(III) chloride. After incipient wetness impregnation, the impregnated hydrotalcites were dried in an oven at 110° C. for 14 hours.

### Comparative Example A

Two alumina-supported rhodium compositions were prepared:

Rh(500)/Al₂O₃ containing 500 ppm (0.050 wt %) Rh on alumina, and

Rh(150)/Al₂O₃ containing 150 ppm (0.015 wt %) Rh on alumina.

These compositions were prepared by incipient wetness impregnation of Pural® alumina with aqueous solutions of Rh(III) chloride. After incipient wetness impregnation, the impregnated aluminas were dried in an oven at 110° C. for 14 hours.

### Example 2

The catalyst compositions according to Example 1 and Comparative Example A were tested for their CO oxidation and their NO reduction capability under FCC regenerator conditions.

Each of the catalyst compositions was blended with a spent (i.e. coke-containing) commercial FCC catalyst in a weight ratio of 1:99. The blends were fluidized in flowing nitrogen and heated to 700° C. Oxygen (2 vol. %) was then introduced into the gas stream and the evolution of CO, CO₂, and NO was measured as a function of time.

The total amount of CO and NO produced using these catalyst compositions, relative to the amounts of CO and NO produced using a commercial Pt-containing CO combustion additive, is reported in Table 1.

TABLE 1

| | CO level relative to | NO level relative to |
|---|---|---|
| Additive | commercial Pt additive | commercial Pt additive |
| commercial Pt additive | 1.00 | 1.00 |
| Rh(500)/Al₂O₃ | 1.17 | 0.76 |
| Rh(150)/Al₂O₃ | 1.00 | 0.55 |
| Rh(500)/HTC | 1.13 | 0.42 |
| Rh(150)/HTC | 0.99 | 0.28 |

This Table shows that Rh supported on anionic clay performs better than Rh supported on alumina. The CO combustion of these compositions is comparable, but the NO reduction is greatly improved by using anionic clay as a support.

1. A fluid catalytic cracking process comprising the step of contacting the gases in an FCC regenerator with a sufficient amount of a catalyst composition comprising rhodium supported on anionic clay such that the NOx and/or CO emissions formed during the fluid catalytic cracking process are reduced.

2. The process according to claim 1 wherein the catalyst composition further comprises Pd, Ag, and/or Cu on the anionic clay.

3. The process according to claim 1 wherein the amount of rhodium on the anionic clay is about 0.01 to about 2.0 wt %, calculated as oxides, and based on the weight of the Rh-supported anionic clay.

4. The process according to claim 1 wherein the catalyst composition additionally comprises alumina.

5. The process according to claim 1 wherein the catalyst composition contains about 1.0 to about 40 wt % of anionic clay, based on the total weight of the catalyst composition.

6. The process according to claim 1 wherein the anionic clay is a Mg—Al anionic clay or Zn—Al anionic clay.

7. (canceled)

8. (canceled)

9. (canceled)

10. (canceled)

11. A NOx and/or CO emissions reduction process for a fluid catalytic cracking process, comprising the steps of:
i) providing a catalyst composition comprising rhodium supported on anionic clay;
ii) regenerating a fluid catalytic cracking catalysts in the presence of said catalyst composition.

12. A fluid catalytic cracking catalyst composition comprising a catalyst additive comprising rhodium supported on anionic clay, and a conventional fluid catalytic cracking catalyst, collectively incorporated into a matrix.

13. The composition of claim 12 wherein the catalyst additive further comprises Pd, Ag, and/or Cu on the anionic clay.

14. The composition of claim 12 wherein the amount of rhodium on the anionic clay is about 0.01 to about 2.0 wt %, calculated as oxides, and based on the weight of the Rh-supported anionic clay.

15. The composition of claim 12 wherein the catalyst additive additionally comprises alumina.

16. The composition of claim 12 wherein the catalyst additive contains about 1.0 to about 40 wt % of anionic clay, based on the total weight of the catalyst composition.

17. The composition of claim 1 wherein the anionic clay is Mg—Al anionic clay of Zn—Al anionic clay.
